(19) United States
(12) Patent Application Publication
(10) Pub. No.: US 2026/0225284 A1
(43) Pub. Date: Aug. 6, 2026

(54) METHODS OF SENSOR WIRE ALIGNMENT AND INSULATIVE MATERIAL PACKING FOR SENSORS, AND RELATED SYSTEMS

(71) Applicant: Battelle Energy Alliance, LLC, Idaho Falls, ID (US)

(72) Inventor: Richard S. Skifton, Idaho Falls, ID (US)

(21) Appl. No.: 19/468,796

(22) Filed: Feb. 3, 2026

Related U.S. Application Data
(60) Provisional application No. 63/753,766, filed on Feb. 4, 2025.

(51) Int. Cl. B28B 23/00

(52) U.S. Cl. CPC B28B 23/0056

(57) ABSTRACT

Methods for orienting sensor wires and packing insulative material within sensors, and corresponding systems. The methods and systems may include a method including positioning one or more sensor wires in a housing of a sensor, filling the sensor housing with one or more insulative materials, and emitting an acoustic frequency in close proximity to the housing, the acoustic frequency is selected to vertically orient the one or more sensor wires relative to the longitudinal axis of the housing and to increase a packing density of the insulative material. A system includes a sensor housing, at least one sensor wire positioned within the sensor housing, and insulative material powder positioned within the sensor housing around the at least one sensor wire. The system includes a sound device configured to emit an acoustic frequency selected to increase a packing density of the insulative material powder around the at least one sensor wire.

### CROSS-REFERENCE TO RELATED APPLICATIONS

This application claims the benefit under 35 U.S.C. § 119(e) of U.S. Provisional Patent Application Ser. No. 63/753,766, filed Feb. 4, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to a sensor system and to methods of material alignment and packing in the sensor system. More specifically, embodiments of the disclosure relate to orientation of sensor wires and packing density of insulative materials in the sensor system and to methods of using acoustic nodal points to orient the sensor wires and pack the insulative materials around the sensor wires.

### BACKGROUND

In various fields, sensors may be disposed in high temperature environments. Accordingly, sensors recording temperature, pressure, shear, strain, and even heat or neutron flux are susceptible to damage without materials that can withstand these demanding environments. Conventional sensors for high temperature applications are usually housed inside a metal outer sheath with ceramic insulation used to keep internal wires isolated from one another. These sensors are commonly referred to as mineral insulated metal sheathed (MIMS) cables. The process of packing mineral insulation is achieved with sleds that slide up the interior of the metal sheath of the sensors. However, these processes are often slow and difficult. Accordingly, more efficient packing solutions for these sensors are desirable in the field.

### BRIEF SUMMARY

A method of forming a sensor including positioning one or more sensor wires in a housing of a sensor, the one or more sensor wires oriented at an angle relative to a longitudinal axis of the housing. The method includes filling the housing with one or more insulative materials. The method includes emitting an acoustic frequency in close proximity to the housing, the acoustic frequency selected to vertically orient the one or more sensor wires relative to the longitudinal axis of the housing and to increase a packing density of the insulative material around the one or more sensor wires.

A method of orienting at least one elongated sensor wire within a sensor housing. The method includes positioning at least one sensor wire within a compartment of a sensor housing, the at least one sensor wire oriented at an initial angle relative to a longitudinal axis of the sensor housing. The method includes adding an insulative material powder to the compartment of the sensor housing, the insulative material powder around the at least one sensor wire at an initial packing density. The method includes emitting an acoustic frequency in close proximity to the sensor housing, the acoustic frequency selected to increase the initial packing density of the insulative material powder around the at least one sensor wire.

A system includes a sensor housing and at least one sensor wire positioned within the sensor housing. The system includes insulative material powder positioned within the sensor housing and around the at least one sensor wire. The system includes a sound device positioned in close proximity to the sensor housing, the sound device configured to emit an acoustic frequency selected to increase a packing density of the insulative material powder around the at least one sensor wire.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 illustrates a sectional view of a sensor system in accordance with embodiments of the disclosure.

FIG. 2 is a flow diagram for a method of aligning a wire sensor and packing insulative material within a sensor housing in accordance with embodiments of the disclosure.

FIGS. 3A-3D illustrate the method of aligning the wire sensor and packing insulative material within the sensor housing in accordance with embodiments of the disclosure.

FIGS. 3A and 3B illustrate sectional views of the sensor system in the X-Z plane in accordance with embodiments of the disclosure.

FIG. 3C illustrates a cross-sectional view of the sensor system of FIGS. 3A and 3B in the X-Y plane in accordance with embodiments of the disclosure.

FIG. 3D illustrates a sectional view of the sensor system of FIGS. 3A-3C in the X-Z plane in accordance with embodiments of the disclosure.

FIG. 4A illustrates a cross-sectional view of a third sensor system in the X-Y plane in accordance with embodiments of the disclosure.

FIG. 4B illustrates a sectional view of the sensor system of FIG. 4A in the X-Z plane in accordance with embodiments of the disclosure.

FIG. 5A illustrates a sectional view of an article in accordance with embodiments of the disclosure.

FIG. 5B illustrates a cross-sectional view of the article of FIG. 5A in the X-Y plane in accordance with embodiments of the disclosure.

### DETAILED DESCRIPTION

The following disclosure presents solutions for efficient orientation of sensor wires and packing of insulative materials within sensor devices (e.g., sensors). The methods and systems disclosed herein may be used to orient the sensor wires (such as sensor cables in mineral insulated metal sheathed sensor devices) parallel to one another inside of a housing of the sensors. The methods and systems disclosed herein may also be used to quickly position the insulative material around the sensor wires and within the housing, while also increasing the packing density of the insulative material around the sensor wires. However, the embodiments herein are not so limited and may be used in various fields involving material alignment and packing. The methods of material packing and alignment may apply acoustic frequencies to create nodal points that form under vibrations from the acoustic frequencies. The nodal points are locations on a vibrating sensor housing that remain stationary, experiencing zero displacement or amplitude due to the vibrations of the sensor housing. The nodal points may be positioned along the sensor housing wherein elongated structures, such as the sensor wires, self-orient. The nodal points may be adjusted based on selection of the vibration intensity. For example, the location of nodal points on the sensor housing may change based on the acoustic frequency applied to the sensor housing. The locations of nodal points may also be dependent on a geometric shape and material of the sensor housing. Smaller sized materials within the housing, such as the insulative material, may self-orient and become packed around the sensor wires, which have a greater mass. The acoustic frequencies may be used to form sensors having substantially aligned sensor wires and densely packed insulative material surrounding the sensor wires.

The illustrations presented herein are not actual views of any sensor system, or any component thereof, but are merely idealized representations, which are employed to describe embodiments of the invention.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As used herein, “conductive material” means and includes electrically conductive material such as one or more of a metal (e.g., tungsten (W), titanium (Ti), molybdenum (Mo), niobium (Nb), vanadium (V), hafnium (Hf), tantalum (Ta), chromium (Cr), zirconium (Zr), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), aluminum (Al)), an alloy (e.g., a Co-based alloy, an Fe-based alloy, an Ni-based alloy, an Fe-and Ni-based alloy, a Co-and Ni-based alloy, an Fe-and Co-based alloy, a Co-and Ni-and Fe-based alloy, an Al-based alloy, a Cu-based alloy, a magnesium (Mg)-based alloy, a Ti-based alloy, a steel, a low-carbon steel, a stainless steel), and a conductive metal-containing material (e.g., a conductive metal nitride, a conductive metal silicide, a conductive metal carbide, a conductive metal oxide). In addition, a “conductive structure” means and includes a structure formed of and including conductive material.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

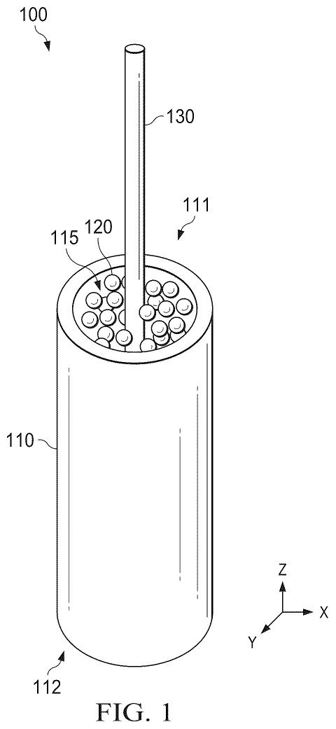

FIG. 1 illustrates a sensor system 100 according to embodiments of the disclosure. The sensor system 100 includes a housing 110, an insulative material 120 disposed in the housing 110, and a sensor wire 130 (e.g., an elongated sensor wire) disposed in the housing 110. As used herein, the term “elongated” means a length substantially greater than a width or height. The sensor system 100 may be a thermal sensor, a pressure sensor, a shear sensor, a strain sensor, or a heat or neutron flux sensor. The insulative material 120 may surround the sensor wire 130.

The housing 110 of the sensor system 100 is illustrated as a cylinder, but may be configured in a variety of shapes, such as a rectangular prism, a cone, a truncated cone, a triangular prism, or a hexagonal prism. The housing 110 may be made of a metal, a metal alloy, a plastic, a ceramic, a combination thereof, or other suitable material known in the art. In some embodiments, the housing 110 may be made of a steel alloy. The housing 110 may have a length in a range from about 4 centimeters to about 100 centimeters. The housing 110 may have a width in a range from about 1 centimeter to about 25 centimeters, from about 2 centimeters to about 12.5 centimeters, or from about 2.5 centimeters to about 10 centimeters.

The housing 110 may include a compartment 115. An interior of the housing 110 may be hollow and have walls with a thickness in a range from about 0.1 centimeters to about 2.5 centimeters, from about 0.25 centimeters to about 1.25 centimeters, or from about 0.5 centimeters to about 1 centimeter. The housing 110 may have an opening 111 opposite a bottom surface 112. Alternatively, the housing 110 may have two openings 111 in each direction along the z-axis. One of the openings 111 may connect to another structure (e.g., another housing 110 of another sensor), which may also be filled with the insulative material 120. The bottom surface 112 may be closed and have a thickness substantially the same as the walls of the housing 110. The bottom surface 112 may be made of the same material as the walls of the housing 110, or may be made of a different metal, metal alloy, plastic, ceramic, or other material. For example, the bottom surface 112 may be an adhesive or glue configured to temporarily close the compartment 115 of the housing 110.

The housing 110 may include the insulative material 120 disposed within the compartment 115. The insulative material 120 may be configured as a powder (e.g., particles, granules). The particles of the insulative material 120 may be sufficiently small to achieve relatively dense packing. The particles of the insulative material 120 may have a diameter (e.g., average diameter) in a range from about 0.05 microns to about 5.0 microns, from about 0.1 microns to about 3.0 microns, or from about 0.5 microns to about 1.0 microns. The insulative material 120 may be sand, a salt, or other sufficiently discrete solid material capable of (e.g., configured for) fluidized movement. The insulative material 120 may, for example, be an oxide compound, a nitride compound, or a combination thereof. For instance, the insulative material 120 may be a ceramic material, such as a metal oxide, a metal nitride, a metal carbide, a metalloid nitride, a metalloid carbide, a boride, a silicate, or a combination thereof. Using a combination of insulative materials 120 within the housing 110 may tailor the ability to more uniformly and densely pack the insulative materials 120 around the sensor wire 130 and the sensor wire 130 to be substantially aligned. The insulative material 120 may include, but is not limited to, aluminum oxide, beryllium oxide, magnesium oxide, aluminum nitride, boron nitride, silicon nitride, silicon carbide, or a combination thereof. The insulative material 120 in powder form may be commercially available from numerous sources, decreasing the cost associated with producing the sensor system 100. The insulative material 120 may at least partially fill the compartment 115 of the housing 110. The insulative material 120 may exhibit insulative properties (e.g., electrically insulative properties, thermally insulative properties), protecting the sensor wire 130 disposed in the housing 110 from external heat sources, which may allow the sensor system 100 to be used in high-temperature environments. In some embodiments, the insulative material 120 is aluminum oxide.

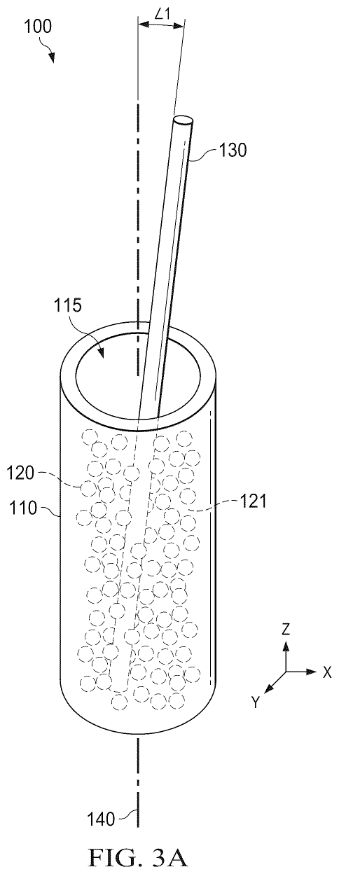

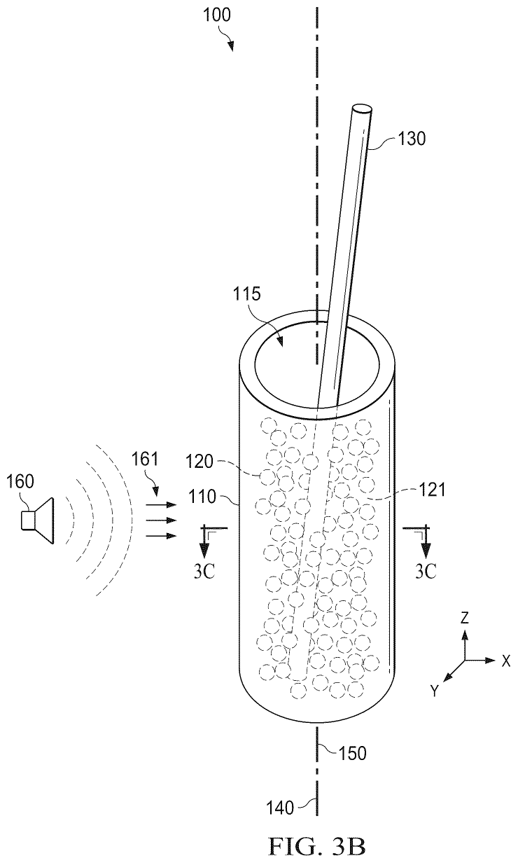

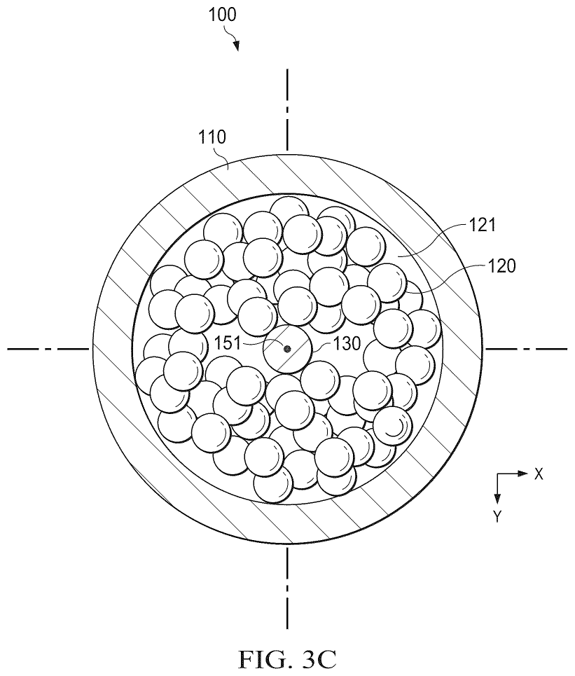

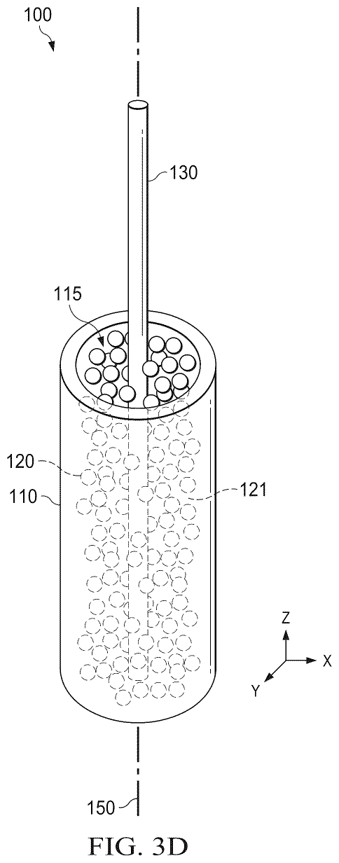

The sensor wire 130 may be partially or wholly disposed within the compartment 115 of the housing 110. The sensor wire 130 may exhibit a variety of cross-sectional shapes but is illustrated in FIG. 1 as cylindrically-shaped for simplicity and convenience. While the sensor wire 130 is depicted as a thin, linear wire, the disclosure is not so limited. The sensor wire 130 may, for example, be curvilinear. The sensor wire 130 may also include multiple wires, such as a twisted pair of wires or a bundle of wires. The sensor wire 130 or multiple sensor wires 130 may be substantially vertically aligned with the longitudinal axis 140 (shown in FIG. 3A) of the housing 110. The sensor wire 130 may be made of a conductive (e.g., an electrically conductive, a thermally conductive) material. In some embodiments, the sensor wire 130 is formed of and includes an alloy of one or more of nickel, chromium, aluminum, and copper. The sensor wire 130 may connect various electrical components of the sensor system 100, such as a resistor, a thermocouple, a thermistor, a diaphragm, or other sensing element, to a receiver or processor. The housing 110 may also have more than one sensor wire 130 disposed within the compartment 115, wherein each sensor wire 130 may be a single wire, a pair of wires, or a bundle of wires spaced apart from other of the sensor wires 130. The one or more sensor wires 130 may be separated from one another by the insulative material 120. The one or more sensor wires 130 may be substantially parallel to the longitudinal axis of the housing 110.

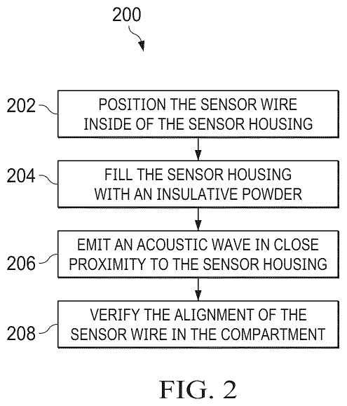

The sensor wire 130 and the insulative material 120 may be positioned (e.g., arranged) within the compartment 115 of the housing 110 by process 200, as shown in FIG. 2, including positioning 202 the wire inside of the sensor housing, filling 204 the sensor housing with the insulative material, emitting 206 an acoustic wave in close proximity to the sensor housing, and verifying 208 the alignment of the sensor wire 130 in the compartment 115, such as with an ohm reader. For example, a resistance as measured by the ohm meter may change when a sensor wire 130 within a sensor housing 110 formed of conductive material is aligned along a longitudinal axis 140 as opposed to a misaligned (e.g., not substantially aligned) sensor wire 130. A portion of a misaligned sensor wire 130 within the sensor housing 110 may be touching the sensor housing 110 or at least positioned closer to the sensor housing 110 than when the sensor wire 130 is properly aligned. The insulative material 120 positioned between the aligned sensor wire 130 and the housing 110 increases the resistance, which can be measured by an ohm reader. For convenience, the process 200 of FIG. 2 is described below with reference to the sensor system 100 of FIG. 1 but is not limited to the embodiment of FIG. 1.

As illustrated in FIG. 3A, the sensor wire 130 may be positioned in the compartment 115 of the housing 110 of the sensor system 100. The sensor system 100 may be oriented in a vertical (e.g., substantially vertical) direction. The compartment 115 may be at least partially filled with the insulative material 120 such that the insulative material 120 surrounds at least a portion of the sensor wire 130. The sensor wire 130 may be oriented at an angle, ∠1, relative to a longitudinal axis 140 of the housing 110. The sensor wire 130 may be displaced from the longitudinal axis 140 in the x and/or y-axes. The insulative material 120 may substantially surround the sensor wire 130 and at least partially fill a volume (e.g., the compartment 115) of the housing 110. The particles of the insulative material 120 may be separated from one another and from the sensor wire 130 by voids 121. The voids 121 may be areas of empty space, such as air pockets, where the insulative material 120 is not densely packed. The voids 121 may be of various sizes throughout the compartment 115 of the housing 110.

As illustrated in FIG. 3B, the housing 110 of the sensor system 100 may be subjected to acoustic frequencies 161 from a sound device 160. The acoustic frequencies 161 may be audible frequencies or ultrasonic frequencies. The acoustic frequencies 161 may be in the range from about 20 Hz to about 1 MHz, such as from about 20 Hz to about 20 kHz or from about 20 kHz to about 1 MHz. The acoustic frequencies 161 may be emitted from the sound device 160 in close proximity to the housing 110, producing acoustic waves and causing vibrations in the housing 110. As used herein, the term “close proximity” means a distance sufficient to cause vibrations in the housing 110 and may depend on the size of the housing 110 as well as the material of the housing 110. The acoustic waves may be produced by the sound device 160 at a distance within a range from about 1 centimeter to about 100 centimeters, from about 2.5 centimeters to about 25 centimeters, or from about 5 centimeters to about 15 centimeters. The vibrations within the housing 110 may cause the insulative material 120 and the sensor wire 130 to vibrate, causing shifting within the housing 110. The sensor wire 130, which is formed of a higher density material than the insulative material 120, is subjected to the acoustic waves and migrates to non-vibrating points within the sensor. The acoustic frequencies 161 may be tuned based on the material and geometry of the housing 110. The sensor system 100 may be oriented vertically so that the z-axis and a longitudinal nodal axis 150 of the sensor system 100 are substantially parallel. The longitudinal nodal axis 150 is an axis along which there is no displacement (∠1 equals zero) due to the vibration of the housing 110. The vertical orientation of the sensor system 100 may be advantageous for uniform packing of the insulative material 120 and facilitated alignment of the sensor wire 130.

With reference to FIG. 3C, the housing 110 may have a nodal point 151 at the center of the cross-section of the housing 110. While the nodal point 151 is illustrated in FIG. 3C as being the center of the cross-section of the housing 110, various nodal point 151 locations are possible, and may depend on the acoustic frequency 161 emitted by the sound device 160, as well as the cross-sectional shape of the housing 110, the diameter of the sensor wire 130, the thickness of the housing 110, particle size of the insulative material 120, the material of the housing 110, and the number of sensor wires 130. The nodal point 151 may correspond to the location in a cross-sectional plane of the housing 110 where there is no movement of the insulative material 120 or the sensor wire 130 due to the vibration of the housing 110 from the acoustic frequencies 161. However, movement in the areas surrounding the nodal point 151 may occur, which cause objects to shift into and out of the nodal point 151, such as the sensor wire 130 displacing the insulative material 120 during emission of the acoustic frequencies 161.

The nodal point 151, being uniform across the cross sections of the housing 110 in the shape of a cylinder, may be along a nodal axis 150 (see FIG. 3D). The nodal axis 150 and the longitudinal axis 140 are the same line as shown in FIG. 3B, but the nodal axis 150, or axes in instances where there are multiple nodal axes 150, may not be the same as the longitudinal axis 140. In various embodiments, the nodal axes 150 may be substantially parallel to the longitudinal axis 140. However, the nodal axes 150 may not necessarily be parallel to the longitudinal axis 140 of the housing 110 in various shapes of the housing 110. Accordingly, some geometries of the housing 110 may produce sloped nodal axes 150, or nodal planes.

The sensor wire 130 may have a greater mass and a greater size than the mass and size of the insulative material 120. As a result, the sensor wire 130 may move toward the nodal axis 150 during vibration of the housing 110 produced by the acoustic frequencies 161 of the sound device 160. In other words, the sensor wire 130 may “self-align” along the nodal axis 150 as the particles of insulative material 120 move within the compartment 115 of the housing 110. Furthermore, the movement of the particles of insulative material 120 may reduce the number and size of the voids 121 within the housing 110 as the insulative material 120 becomes more densely packed around the sensor wire 130. As the insulative material 120 settles (e.g., the packing density increases) around the sensor wire 130, additional insulative material 120 may be added to the housing 110 during or between the emission of the acoustic frequencies 161 from the sound device 160. The sound device 160 may be moved along the length of the housing 110 to uniformly emit the acoustic frequencies 161 along the length of the housing 110. Alternatively, multiple sound devices 160 may be positioned along the length of the housing 110 to uniformly emit the acoustic frequencies 161 along the length of the housing 110. The acoustic frequencies 161 may be emitted for a time from about 2 seconds to about 2 minutes, from about 5 seconds to about 1 minute, or from about 10 seconds to about 30 seconds. The amount of time that the acoustic frequencies 161 are emitted may depend on the size, shape, material, and thickness of the housing 110, dimensions (e.g., diameter, length) of the sensor wire 130, the particle size of the insulative material 120, the type and amount of insulative material 120 used, the type of acoustic frequency 161 emitted, and the distance of the sound device 160 from the housing 110.

The acoustic frequencies 161 emitted from the sound device 160 may then be ceased. Following the application and cessation of the acoustic frequencies 161, the sensor wire 130 may be positioned along the nodal axis 150 of the housing 110, as illustrated in FIG. 3D. In other words, the sensor wire 130 may be substantially vertical in orientation relative to the longitudinal axis 140 of the housing 110 and the angle ∠1 may be zero. The insulative material 120 may be tightly packed around the sensor wire 130 and within the housing 110, leaving fewer and smaller voids 121. Accordingly, alignment of the sensor wire 130 along the nodal axis 150 and more uniform packing of the insulative material 120 surrounding the sensor wire 130 is achieved, minimizing the presence and size of the voids 121. The insulative material 120 may electrically isolate the sensor wire 130, protect the sensor wire 130, and increase thermal transfer properties of the sensor system 100. Once the sensor wire 130 is substantially vertically aligned and the insulative material 120 is more densely packed, the alignment of the sensor wire 130 may be verified with an ohm reader or other method known in the art to verify electrical wiring. As discussed above, the ohm reader may determine an increase in resistance used to determine proper alignment of the sensor wire 130 within the housing 110. Other methods to determine alignment of the sensor wire 130 may include a computed tomography scan or an X-ray scan.

While FIGS. 3C and 3D illustrate the alignment of the sensor wire 130 within a single sensor system 100, multiple sensors 100 may be aligned at the same time (e.g., substantially simultaneously). One or more of the sensors 100, each having a sensor wire 130 and insulative material 120 disposed in the compartment 115, may be subjected to the acoustic frequencies 161 from one or more sound devices 160 at the same time. Accordingly, the sensors 100 may undergo an alignment process substantially simultaneously, allowing for bulk processing of the sensors 100 to achieve the desired orientation of the sensor wires 130 and efficient packing of the insulative material 120 surrounding the sensor wires 130.

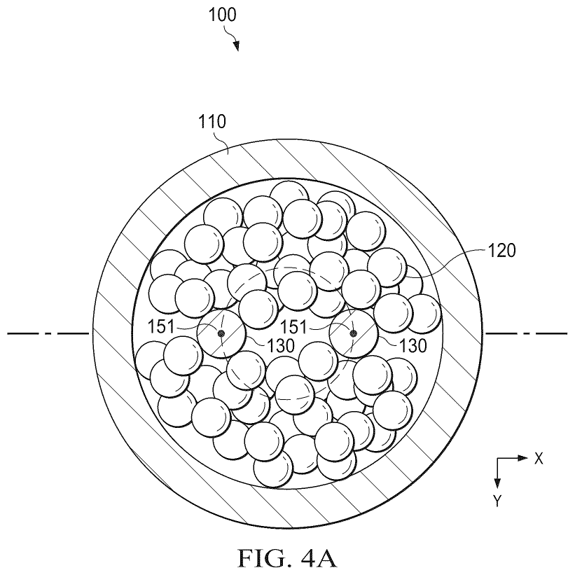

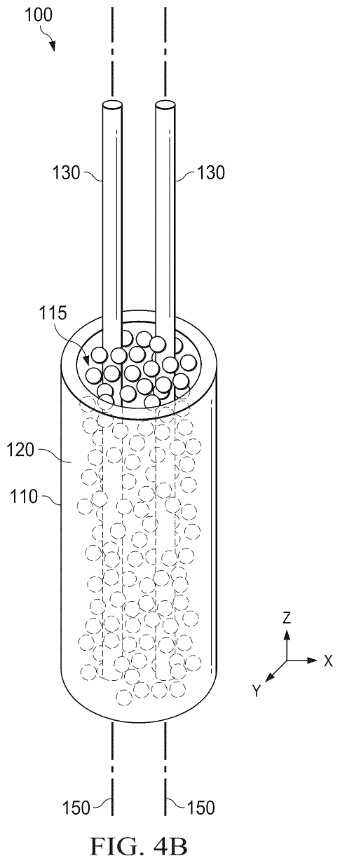

Different acoustic frequencies 161 may be used to produce different nodal points 151, such as using ultrasonic frequencies compared to audible frequencies. As shown in FIG. 4A, the housing 110 may have two nodal points 151 along a cross-section of the housing 110. However, greater or fewer than two nodal points 151 may be present depending on the acoustic frequency 161 used as well as the geometric shape and material of the housing 110. The nodal points 151 may fall along (e.g., correspond to) nodal axes 150 of the housing 110, as shown in FIG. 4B. The nodal axes 150 are illustrated as parallel to one another in the embodiment of FIG. 4B but may be nonparallel depending on the shape and material of the housing 110. Furthermore, in embodiments with more than two nodal axes 150, more than two nodal points 151 may be present at a cross-section of the housing 110.

The use of different acoustic frequencies may allow self-alignment of multiple sensor wires 130 within a single housing 110. Two or more sensor wires 130 may be aligned in parallel at different positions within the housing 110, allowing for even spacing between the sensor wires 130 across the length of the housing 110. Various advantages of the uniform spacing will be appreciated by those of ordinary skill in the art. Alternatively, housings 110, such as truncated cones, may have non-parallel nodal axes 150 and the alignment methods described herein may allow for spatial configurations as a function of housing width or other housing parameters.

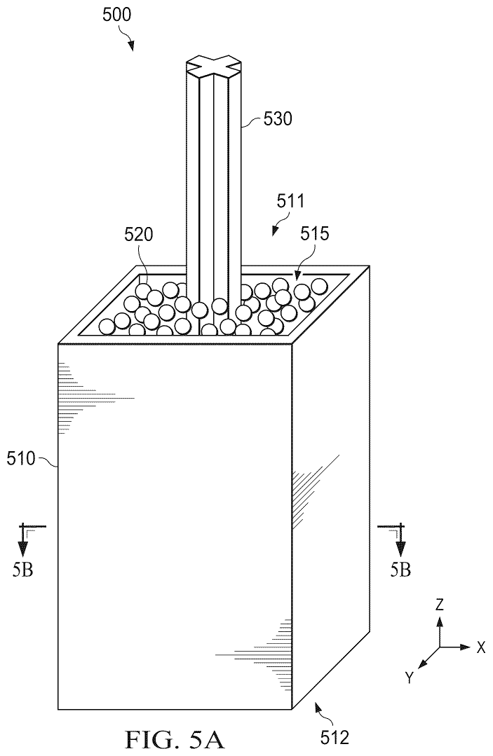

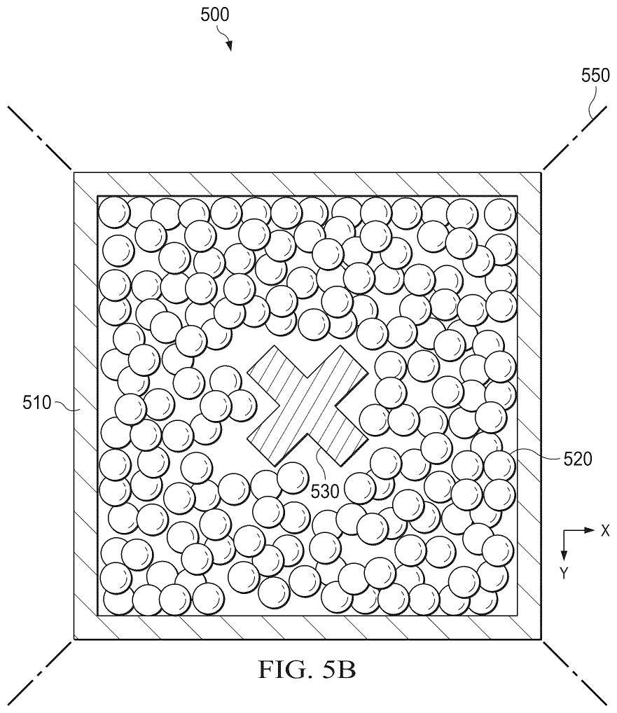

While the previous methods and embodiments are described with reference to sensors 100, the disclosure is not so limited. The methods of packing and alignment may be utilized in housings of various devices or structures with an object or objects disposed therein. As shown in FIG. 5A, an article 500 may have a housing 510, an insulative material 520 disposed in a compartment 515, and an elongated structure 530 disposed in the compartment 515. The article 500 may be shaped, for example, as a rectangular prism. The housing 510 of the article 500 may have an opening 511 and a bottom surface 512. The compartment 515 may be defined by the interior boundary of the housing 510, which may have walls of a thickness in a range from about 0.1 centimeters to about 2.5 centimeters, from about 0.25 centimeters to about 1.25 centimeters, or from about 0.5 centimeters to about 1 centimeter. The housing 510 may be made of a variety of materials, such as a metal, a metal alloy, concrete, wood, a plastic, a ceramic, or combinations thereof. In some embodiments, the housing 510 may be made of polyvinyl chloride. The insulative material 520 may be disposed within the compartment 515. The insulative material 520 may be a powder, sand, salt, or other sufficiently discrete solid capable of fluidized movement, including one or more of the materials described in reference to previous embodiments.

As shown in FIG. 5B, a cross section of the article 500 may have one or more nodal lines 550 that result from the application of acoustic frequencies 161 (such as those shown in FIG. 3B) to the housing 510. The nodal lines 550 may become nodal planes across the length of the article 500 following the application of acoustic frequencies 161. The elongated structure 530 may exhibit a so-called “x-shape” when viewed in the perspective of FIG. 5B. The elongated structure 530 may, however, exhibit various other cross-sectional shapes, such as square, rectangular, circular, or other shapes. The elongated structure 530 may also exhibit a non-geometric shape. Furthermore, the elongated structure 530 may exhibit a substantially annular shape or otherwise have an interior portion that is hollow. The elongated structure 530 may be made of various materials, such as a metal, a metal alloy, a plastic, wood, or a ceramic. In some embodiments, the elongated structure 530 may be made of polyvinyl chloride.

Acoustic frequencies 161 applied to the housing 510 may cause the elongated structure 530 to self-align in various positions along the nodal lines 550 of the cross section of the article 500. The housing 510 of the article 500 may be subjected to the acoustic frequencies 161 as described above in reference to FIG. 3B. The acoustic frequencies 161 may be emitted from the sound device 160 positioned in close proximity to the housing 510 of the article 500 and may be moved along the length of the article 500. In embodiments where the elongated structure 530 has a substantially x-shaped cross section, the elongated structure 530 may, for example, be aligned near an intersection of the nodal lines 550 as illustrated in FIG. 5B. The elongated structure 530 may be aligned within the housing 510 of various articles 500. Alternatively, the elongated structure 530 having a different width and height may self-orient along the longer dimension along one of the two nodal lines 550. Various shapes of the article 500 may create different nodal zones (i.e., nodal points, nodal lines, or nodal planes) for a given planar section of the article 500. Similarly, various acoustic frequencies 161 may create different nodal zones.

The sensor system 100 or article 500 according to embodiments of the disclosure may be used in a high temperature environment to measure one or more parameter, such as one or more of temperature, pressure, shear, strain, heat flux, or neutron flux. The sensor system 100 or article 500 may, for example, be a sensor cable in a mineral insulated metal sheathed sensor device. The sensor system 100 or article 500 may be configured for use at a temperature greater than or equal to about 2000° C. By way of example only, the sensor system 100 or article 500 may be used in a nuclear reactor to measure temperature. However, the sensor system 100 or article 500 may be used in other high temperature environments. Additionally, the article 500 may be used in various fields, such as construction, machining, cable manufacturing, etc.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of forming a sensor, comprising:
positioning one or more sensor wires in a housing of a sensor, the one or more sensor wires oriented at an angle relative to a longitudinal axis of the housing;
filling the housing with one or more insulative materials; and
emitting an acoustic frequency in close proximity to the housing, the acoustic frequency selected to vertically orient the one or more sensor wires relative to the longitudinal axis of the housing and to increase a packing density of the insulative material around the one or more sensor wires.

2. The method of claim 1, wherein filling the housing with an insulative material comprises filling the housing with particles of the insulative material.

3. The method of claim 1, wherein emitting an acoustic frequency in close proximity to the housing comprises orienting the one or more sensor wires parallel to the longitudinal axis of the housing.

4. The method of claim 1, wherein emitting an acoustic frequency in close proximity to the housing to vertically orient the one or more sensor wires comprises emitting the acoustic frequency across a length of the housing.

5. The method of claim 1, further comprising adding additional insulative material to the housing after emitting the acoustic frequency in close proximity to the housing.

6. The method of claim 1, wherein emitting the acoustic frequency in close proximity to the housing comprises moving a sound device along a length of the housing.

7. The method of claim 1, wherein emitting the acoustic frequency in close proximity to the housing comprises emitting ultrasonic frequencies from a sound device.

8. The method of claim 1, further comprising verifying an alignment of the one or more sensor wires along a nodal axis of the housing after emitting the acoustic frequency in close proximity to the housing.

9. A method of orienting at least one elongated sensor wire within a sensor housing, comprising:
positioning at least one sensor wire within a compartment of a sensor housing, the at least one sensor wire oriented at an initial angle relative to a longitudinal axis of the sensor housing;
adding an insulative material powder to the compartment of the sensor housing, the insulative material powder around the at least one sensor wire at an initial packing density; and
emitting an acoustic frequency in close proximity to the sensor housing, the acoustic frequency selected to increase the initial packing density of the insulative material powder around the at least one sensor wire.

10. The method of claim 9, wherein positioning at least one sensor wire within a compartment of a sensor housing comprises positioning multiple wires within the compartment.

11. The method of claim 10, wherein adding the insulative material powder comprises separating individual wires of the multiple wires by the insulative material powder.

12. The method of claim 10, wherein adding the insulative material powder comprises separating bundles of wires of the multiple wires by the insulative material powder.

13. The method of claim 9, wherein adding the insulative material powder comprises filling the sensor housing with a thermally conductive material powder.

14. The method of claim 9, wherein filling the sensor housing with an insulative material powder comprises filling the sensor housing with the insulative material powder comprising aluminum oxide, beryllium oxide, magnesium oxide, aluminum nitride, boron nitride, silicon nitride, silicon carbide, or a combination thereof.

15. The method of claim 9, wherein emitting an acoustic frequency in close proximity to the sensor housing comprises moving the at least one sensor wire from the initial angle relative to the longitudinal axis of the sensor housing to a different angle.

16. The method of claim 9, wherein emitting an acoustic frequency in close proximity to the sensor housing comprises emitting the acoustic frequency at a frequency from about 20 Hz to about 20 kHz.

17. The method of claim 9, wherein emitting an acoustic frequency in close proximity to the sensor housing comprises emitting the acoustic frequency at a frequency 20 kHz to about 1 MHz.

18. The method of claim 9, wherein emitting an acoustic frequency in close proximity to the sensor housing comprises emitting the acoustic frequency at a distance from about 1 centimeter to about 100 centimeters away from the sensor housing.

19. A system comprising:
a sensor housing;
at least one sensor wire positioned within the sensor housing;
insulative material powder positioned within the sensor housing and around the at least one sensor wire; and
a sound device positioned in close proximity to the sensor housing, the sound device configured to emit an acoustic frequency selected to increase a packing density of the insulative material powder around the at least one sensor wire.

20. The system of claim 19, wherein the sound device is configured to emit ultrasonic frequencies and the insulative powder comprises aluminum oxide.
